(19) United States
(12) Patent Application Publication
(10) Pub. No.: US 2026/0298770 A1
(43) Pub. Date: Oct. 1, 2026

(54) METHODS, APPARATUS AND SYSTEMS FOR POLARIZATION EXTINCTION RATIO DETECTION OF MULTI-FIBER DEVICES

(71) Applicant: Santec Canada Corporation, Ottawa (CA)

(72) Inventors: Guillaume Paradis, Ottawa (CA); Ryan Veenkamp, Ottawa (CA)

(21) Appl. No.: 19/096,619

(22) Filed: Mar. 31, 2025

(51) Int. Cl. G01M 11/00

(52) U.S. Cl. CPC G01M 11/33

(57) ABSTRACT

A polarization extinction ratio detector for a multi-fiber device. The detector comprises an adaptor for coupling the multi-fiber device to the detector; a photodetector for converting light to an electrical signal; a polarizer that is rotatable with respect to the photodetector; and at least one passive wide-area optical element. The photodetector, polarizer and at least one passive wide area optical element are positioned such that, when the multi-fiber device is coupled to the detector, light output by any fiber of the multi-fiber device follows an optical path through the polarizer and the at least one wide-area optical element to generate a collimated beam that is focused on the photodetector.

### TECHNICAL FIELD

The disclosed example embodiments relate to methods, apparatus and systems for testing of optical fibers and more specifically for measuring the polarization extinction ratio (PER) of optical fibers.

### BACKGROUND

An optical fiber is a thin flexible strand of glass or plastic that can transmit light from one end to the other. Optical fibers operate on the principle of total internal reflection (TIR), which allows light to travel through the fiber by continuously bouncing off the inner walls of the fiber core, without escaping. A fiber optic cable can comprise one or more optical fibers inside an insulating casing. Fiber optic cables are widely used in telecommunications, medical equipment, and networking, owing to their high capacity for data transmission and resistance to electromagnetic interference.

Light is a transverse electromagnetic wave and the electric field of this wave oscillates perpendicularly to the direction of propagation. Light is unpolarized if the direction of this electric field fluctuates randomly in time. If, however, the direction of the electric field is well defined, it is called polarized light. There are three types of polarized light that depend on how the electric field is oriented. Linear polarization is where the electric field is confined to a single plane along the direction of propagation. Circular polarization is where the electric field consists of two linear components that are perpendicular to each other, equal in application, but have a phase difference of π/2. This results in an electric field that rotates in a circle around the direction of propagation. Elliptical polarization is where the electrical field of light describes an ellipse. This results from two linear components with different amplitudes and/or a phase difference that is not π/2.

As noted above, light guided by optical fiber is constrained to the fiber core by total internal reflection (TIR) at the walls of the fiber. This introduces phase changes that are a function of the polarization state of the light. Linearly polarized light that propagates through a symmetrical single-mode fiber will retain its polarization state. However, most optical fibers are not completely symmetrical nor is it possible to ensure that they stay completely straight. Furthermore, bending or twisting a fiber will induce birefringence. Birefringence is an optical property of a material where the reflective index is dependent on the polarization and direction of the propagating light. Birefringence can cause double refraction where a ray of light, incident on a birefringent material, splits into two rays which are linearly polarized in mutually orthogonal planes or circularly-polarized in opposite directions. This can result in the polarization varying along the length of the fiber in an unpredictable, and wavelength-dependent, way. Thus, the output state of polarization may be random.

Instead of trying to produce a perfectly symmetrical fiber that will maintain the polarization state, fiber optic cables have been developed with high birefringence. These are referred to as polarization-maintaining (PM) fibers. One method for introducing strong birefringence is to include a plurality (e.g., two) stress rods of a modified glass composition in the preform on opposite sides of the core which cause mechanical stress with a well-defined orientation. Specifically, they introduce systematic linear birefringence so that there are two well defined polarized modes which propagate along the fiber. This means that if linearly polarized light is input into a PM fiber aligned with one of the polarization modes the light maintains its linear polarization during propagation.

The performance of a PM fiber may be measured via the polarization extinction ratio (PER). The PER is a measure of how well light is confined within a principal linear polarization mode after traveling through a device or system. It is defined as shown in equation (1) as the ratio of optical powers of perpendicular polarizations, usually referred to as transverse electric (TE) and transverse magnetic (TM). PER is often expressed in dB as shown in equation (2).

$$PER = \frac{{P}_{TE}}{{P}_{TM}} \qquad ( 1 )$$

$${PER}_{dB} = 10 \cdot {log}_{10} ( \frac{{P}_{TE}}{{P}_{TM}} ) \qquad ( 2 )$$

Accordingly, PER is an importance metric for assessing the performance of devices, such as a PM fiber, that requires that light propagating through them remain linearly polarized and aligned to a particular axis.

### SUMMARY

The following summary is intended to introduce the reader to various aspects of the detailed description, but not to define or delimit any invention.

A first aspect provides a polarization extinction ratio detector for a multi-fiber device, the detector comprising: an adaptor for coupling the multi-fiber device to the detector; a photodetector for converting light to an electrical signal; a polarizer that is rotatable with respect to the photodetector; and at least one passive wide-area optical element; wherein the photodetector, polarizer and at least one passive wide area optical element are positioned such that, when the multi-fiber device is coupled to the detector, light output by any fiber of the multi-fiber device follows an optical path through the polarizer and the at least one wide-area optical element to generate a beam that is focused on the photodetector.

The at least one passive wide-area optical element may comprise a plurality of passive wide-area optical elements.

The polarizer may be positioned in the optical path between two of the plurality of passive wide-area optical elements.

The polarizer may be positioned in the optical path before each of the at least one passive wide-area optical element.

The polarizer may be positioned in the optical path after each of the at least one passive wide-area optical element.

An axis of rotation of the polarizer is parallel to an optical axis of the multi-fiber device.

The detector may further comprise a motor coupled to the polarizer for driving the rotation of the polarizer.

The photodetector may be mounted to a stationary shaft and the polarizer may be mounted to a rotatable shaft of the motor that is concentric with the stationary shaft.

Each of the at least one passive wide-area optical element may be a light collecting lens.

The at least one passive wide-area optical element may comprise a pair of plano-aspherical lenses.

The detector may further comprise a measurement device coupled to the photodetector, the measurement device configured to generate the PER for a fiber of the multi-fiber device based on the electrical signal generated by the photodetector while that fiber is outputting light.

The detector may further comprising a rotation sensor, and wherein the polarizer is coupled to a trigger element that rotates with the polarizer and the rotation sensor is configured to detect when the trigger element is in a predetermined position and, in response to detecting that the trigger element is in the predetermined position, send a trigger signal to the measurement device which causes the measurement device to obtain a plurality of samples of the electrical signal.

The rotation sensor may comprise a photo-interrupter.

The measurement device may be further configured to determine a polarization angle for the fiber based on the electrical signal generated by the photodetector while that fiber is outputting light.

The measurement device may comprise an optical power measurement device.

The detector may further comprise a diverging lens positioned such that a collimated beam passes through the diverging lens before being passed through the polarizer and the at least one passive wide-angle optical element.

The photodetector may be a photodiode.

The adaptor may be configured to receive a fiber array unit (FAU).

A second aspect provides a method of determining a polarization extinction ratio (PER) of multiple fibers in a multi-fiber device, the method comprising: (a) coupling the multi-fiber device to a PER detector; (b) receiving, at the PER detector, light from a fiber of the multi-fiber device; (c) passing the received light through a rotating polarizer and at least one wide-area optical element of the PER detector to generate a beam that is focused on a photodetector of the PER detector, the rotating polarizer rotating with respect to the photodetector; (d) converting, at the photodetector, the beam into an electrical signal; (e) generating the PER for the fiber based on the electrical signal generated by the photodetector; and (f) while the multi-fiber device is coupled to the PER detector, repeating (b) to (e) for a different fiber of the multi-fiber device.

A third aspect provides a system for determining a polarization extinction ratio (PER) of each fiber in a multi-fiber device, the system comprising: a light source; a multi-fiber switching unit coupled to the light source; a first adapter for coupling a first end of a multi-fiber device to the multi-fiber switching unit, the multi-fiber switching unit configured to automatically cause the light source to sequentially provide light to each fiber of the multi-fiber device; a second adaptor for coupling a second end of the multi-fiber device to a PER detector, the PER detector comprising: a photodetector for converting light to an electrical signal, a polarizer that is rotatable with respect to the photodetector, and at least one passive wide-area optical element; wherein the photodetector, polarizer and at least one passive wide area optical element are positioned such that light output by any fiber of the multi-fiber device follows an optical path through the polarizer and the at least one wide-area optical element to generate a beam that is focused on the photodetector; and a measurement device coupled to the photodetector, the measurement device configured to generate the PER for each fiber of the multi-fiber device based on the electrical signal generated by the photodetector while that fiber is outputting light.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is schematic diagram illustrating the rotating polarizer method of measuring PER;

FIG. 2 is a schematic diagram illustrating the optical components and optical path through the optical components of a first example PER detector for multi-fiber devices;

FIG. 3 is a schematic diagram illustrating the optical components and optical path through the optical components of a second example PER detector for multi-fiber devices;

FIG. 4A is an isometric view of an example PER detector for multi-fiber devices with the optical components and optical path shown in FIG. 2;

FIG. 4B is an isometric view of a cross section of the example PER detector along line A-A (shown in FIG. 4C);

FIG. 4C shows a front view of the PER detector;

FIG. 4D shows a side view of a cross section of the PER detector along line A-A;

FIG. 5 is an exploded view of the motor and the stationary shaft mounting plate of the example PER detector of FIGS. 4A-4D;

FIG. 6A is a first exploded view of the motor of the PER detector of FIGS. 4A-4D with the stationary shaft mounting plate attached thereto, and the stationary shaft of the example PER detector of FIGS. 4A-4D;

FIG. 6B is a second exploded view of the motor of the PER detector of FIGS. 4A-4D with the stationary shaft mounting plate attached thereto (“combination 1”), and the stationary shaft of the example PER detector of FIGS. 4A-4D;

FIG. 6C is a first isometric view of the stationary shaft of the PER detector of FIGS. 4A-4D attached to combination 1 (“combination 2”);

FIG. 6D is a second isometric view of the stationary shaft of the PER detector of FIGS. 4A-4D attached to combination 1 (“combination 2”);

FIG. 7A is an exploded view of the rotating block of the PER detector of FIGS. 4A-4D and combination 2;

FIG. 7B is an isometric view of the rotating block of the PER detector of FIGS. 4A-4D connected to combination 2 (“combination 3”);

FIG. 8A is an exploded view of the lenses and the lens block of the PER detector of FIGS. 4A-4D;

FIG. 8B is an isometric view of the lens block of the PER detector of FIGS. 4A-4D with the lenses mounted within;

FIG. 9A is an exploded view of the lens block of the PER detector of FIGS. 4A-4D and combination 3;

FIG. 9B is an isometric view of the lens bock of the PER detector of FIGS. 4A-4D attached to combination 3 (“combination 4”);

FIG. 10A is an exploded view of the outer case of the PER detector of FIGS. 4A-4D and combination 4;

FIG. 10B is an isometric view of the outer case of the PER detector of FIGS. 4A-4D and combination 4 (“combination 5”);

FIG. 11A is an exploded view of the polarizer plate and the polarizer of the PER detector of FIGS. 4A-4D;

FIG. 11B is an isometric view of the polarizer plate of the PER detector of FIGS. 4A-4D with the polarizer inserted therein;

FIG. 11C is an exploded view of the polarizer plate of the PER detector of FIGS. 4A-4D and combination 5;

FIG. 11D is an isometric view of the polarizer plate of the PER detector of FIGS. 4A-4D attached to combination 5 (“combination 6”);

FIG. 12A is an exploded view of the adaptor plate of the PER detector of FIGS. 4A-4D and combination 6;

FIG. 12B is an isometric view of the adaptor plate of the PER detector of FIGS. 4A-4D attached to combination 6;

FIG. 13 is a block diagram of an example system for automatically measuring the PER of each fiber of a multi-fiber device that comprises the PER detector of FIGS. 4A-4D; and

FIG. 14 is an example method for measuring the PER of one or more fibers of a multi-fiber device using the PER detectors described herein.

### DETAILED DESCRIPTION

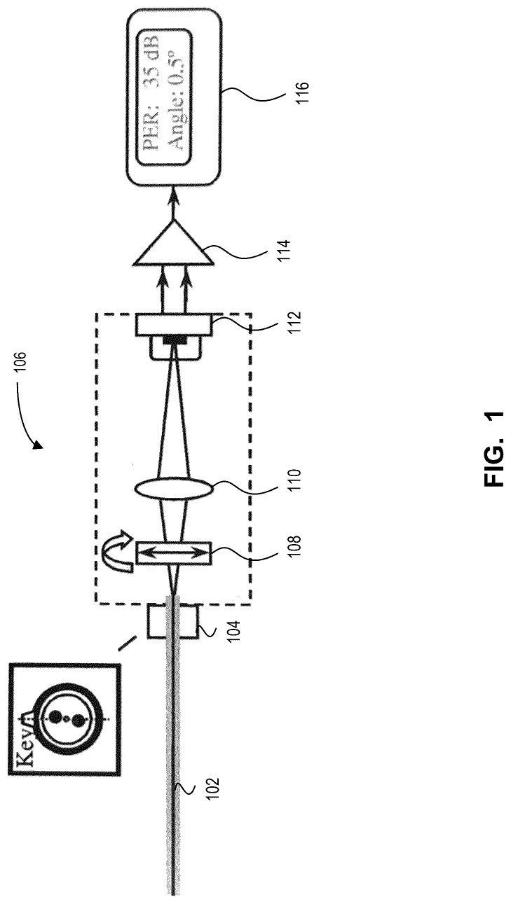

One method for measuring PER is referred to as the rotating polarizer method. This method is illustrated in FIG. 1, which is taken from Polarization Measurement and Control in Optical Fiber Communication and Sensor Systems, X. Steve Yao and Xiaojun Chen, p. 311. Specifically, in this method the device under test, such as a PM fiber 102, is connected, via a bare fiber adapter 104, to a PER meter 106. The PER meter 106 comprises a rotating polarizer 108 following by an optical lens 110 and a photodetector 112. The rotating polarizer 108 is placed in the path of the light beam from the device under test (e.g., PM fiber 102) and the power of the light transmitted through the polarizer 108 as it is rotated is measured using the photodetector 112. Specifically, the optical lens 110 captures the light that passes through the rotating polarizer and directs it to the photodetector 112. The photodetector 112 converts the light received thereby to an electrical signal which is proportional to the incident optical light. The electrical signal generated by a photodetector 112 can be converted, by, for example, an amplifier 114, to power. The maximum power (PMAX) and minimum power (PMIN) over a full rotation of the polarizer (which correspond to the power of the principal linear polarization state and the power of the orthogonal polarization state respectively) are identified and used to determine the PER as set out in equation (3). The computed PER may then be displayed on a display 116.

$${PER}_{dB} = 10 \cdot {log}_{10} ( \frac{{P}_{MAX}}{{P}_{MIN}} ) \qquad ( 3 )$$

One of the issues with known PER detectors is that they are designed for single fiber devices. To use such PER detectors to test multi-fibers devices and components such as, but not limited to, multi-fiber optical cables, fiber array units (FAUs) and external laser form-factor pluggables (ELSFPs), either the device under test or the PER detector is adjusted through a manual or motorized process after each PER measurement of a fiber to align the next fiber with the PER detector. If performed manually this re-alignment is time consuming (e.g., can take up to 10 minutes to measure the PER of each fiber of a 12-fiber device) and requires a highly skilled person, and even then, can be prone to errors due to misalignment. Implementing the alignment through a motorized process reduces the skill level of the operator, but it significantly increases the complexity of the system and the probability of failure. As the number of multi-fiber devices, such as, but not limited to co-packaged optics (CPOs) and FAUs, increases and enters high volume production it would be desirable to have an efficient and accurate way of measuring the PER of multi-fiber devices.

Accordingly, described herein are PER detectors for measuring the PER of a multi-fiber device. In particular, the PER detectors described herein allow measurement of the PER on all fibers of a multi-fiber device without manual or motorized alignment intervention. This is implemented through the use of integrated wide-area optics to capture light from all fibers of a multi-fiber device. Accordingly, once a multi-fiber device is coupled to a PER detector described herein the PER detector can be used to measure the PER of any and all of the fibers.

The PER detectors for a multi-fiber device comprise an adaptor for coupling the multi-fiber device to the detector, a photodetector, a polarizer that is rotatable with respect to the photodetector and one or more passive wide-area optical element. The photodetector, polarizer and one or more passive wide-area optical element are positioned such that, when a multi-fiber device is coupled to the detector (e.g., via the adaptor), light output by any fiber of the multi-fiber device follows an optical path through the polarizer and the one or more passive wide-area optical element to generate a beam that is focused on the photodetector.

The polarizer is an optical filter that lets light waves of a specific polarization pass through while blocking light waves of other polarizations. As the polarizer rotates, the specific polarization that passes through the polarizer changes. Over a 180 degree rotation, there will be a point where the polarizer only allows light waves with the principal linear polarization and a point where the polarizer only allows light waves with the orthogonal polarization. It is assumed that when the polarizer only allows light waves with the principal linear polarization, the power of the light waves that are output from the polarizer will be the highest; and when the polarizer only allows light waves with the orthogonal linear polarization, the power of the light waves that are output from the polarizer will be the lowest. The polarizer is thus configured to filter the light output from (or received by) a fiber of the multi-fiber device. As described in more detail below, the polarizer may receive the light output from a fiber of a multi-fiber device under test directly (e.g., from the adapter) or via one or more passive wide-area optical elements. In some cases, the PER detector may comprise a motor for driving the rotation of the polarizer.

The one or more wide-area optical element is configured to capture light in the optical path and direct it such that ultimately the light that is passed through the polarizer is focused on the photodetector. The term “optical element” is used herein to mean a component in an optical system that can modify the path of light. Optical elements include, but are not limited to, lenses, mirrors and prisms. In some cases, at least one of the wide-area optical elements is an optical lens. An optical lens is a transparent optical component made from glass, plastic or another transparent material that focuses or disperses light through refraction. Lenses are typically shaped to manipulate the path of light, bending it to converge (focus) or diverge (spread out), depending on the type of lens. In some cases, one or more of the wide-area optical elements is a plano-aspherical lens. An aspherical lens is a lens with surfaces that are not portions of a sphere.

The term “wide-area” optical element is used herein to mean an optical element that can capture optical light over a wide area, and specifically an optical element that can capture light from more than one fiber at the same time (i.e., cover a wide field of view relative to the size of a single fiber). In some cases, the wide-area optical elements are able to accept light from a 12 fiber MPO connector or 24 fiber array which have about a 3 mm wide acceptance area. Accordingly, it is the wide-area aspect of the optical elements that allows the PER detectors described herein to capture and process light from any fiber of a multi-fiber device.

In some cases, there may be only one passive wide-area optical element. In other cases, there may be multiple passive wide-area optical elements. For example, in some cases there may be a pair of wide-area optical elements.

The polarizer and the one or more passive wide-area optical element can be in any order in the optical path. For example, in some cases, the polarizer may be positioned in the optical path so that it precedes all of the passive wide-area optical elements. In these cases, the one or more passive wide-area optical element may be configured to capture the light output by the polarizer and focus the captured light on the photodetector. In other cases, the polarizer may be positioned in the optical path after all of the passive-wide area optical elements. In these cases, the one or more passive wide-area optical elements may be configured to capture the light output from a fiber of the multi-fiber device and direct the light to the polarizer in such a manner that the light output from the polarizer is focused on the photodetector. In yet other cases, where there are a plurality of passive wide-area optical elements, the polarizer may be positioned in the optical path between two of the passive wide-area optical elements. In some of these cases, one of the passive wide-area optical elements may be configured to capture the light output from a fiber of the multi-fiber device and direct the light to the polarizer, and another one of the passive wide-area optical elements may be configured to capture the light output by the polarizer and focus the captured light on the photodetector. In some cases, where there are a plurality of passive wide—are optical elements the first passive wide-area optical element in the optical path may be a collimating lens and a subsequent passive wide-area optical element in the optical path may be a focusing lens.

The photodetector is a device that captures light and converts it into an electrical signal that represents the captured light. In some cases, the electrical signal is proportional to the incident optical input, and specifically the intensity of the incident optical input. There are many known types of photodetectors. The photodetector may be implemented in any suitable manner. In some cases, the photodetector may be a photodiode. A photodiode is a semiconductor device with a PN junction. Incident light generates electron-hole pairs in the depletion region of the junction, producing a current.

The electrical signal generated by the photodetector can be used to determine the power of the light that passes through the polarizer and thus the PER. In some cases, the electrical signal output by the photodetector while light is being output on a fiber of the multi-fiber device for a certain degree of rotation of the polarizer (e.g., 180 degrees) is provided to a measurement device which is configured to determine the PER of that fiber therefrom. Specifically, the measurement device may be configured to sample the electrical signal at multiple points in time, and convert the samples into power measurements, determine the maximum power measurement and minimum power measurement of the samples, and determine the PER therefrom (e.g., in accordance with equation (3)). Where the electrical signal is a current the measurement device may be configured to convert a sample a power measurement using an analog to digital converter.

In some cases, the measurement device may also be configured to compute the polarization angle. The polarization angle is the angular position of maximum power which can be deduced from the known rotation speed of the polarizer and the number of samples or data points.

In some cases, the PER detectors may comprise a mechanism for detecting the current angle of rotation of the polarizer. For example, in some cases, the PER detector may comprise a marker or trigger that rotates with the polarizer and a rotation sensor that is configured to detect the trigger when the trigger (and thus the polarizer) is at a predetermined angle of rotation (e.g., 0 degrees) and, when it is detected that the trigger is at the predetermined angle of rotation, output a trigger signal. For example, in some cases, the trigger is a physical component, and the rotation sensor is a photo-interrupter that detects the trigger when the trigger physically breaks the transmit and receive path of the photo-interrupter. The trigger signal may be used to notify the measurement device when to start sampling the electrical signal output by the photodetector.

In some cases, the PER detector may further comprise a diverging lens positioned such that the light received at the adaptor input passes through the diverging lens before being passed through the polarizer and the at least one passive wide-angle optical element. The light output from a fiber is generally un-collimated. However, if the PER detector can receive collimated light, then placing a diverging lens in front of any passive wide area optic elements allows such light to be treated in the same manner as light output from a fiber.

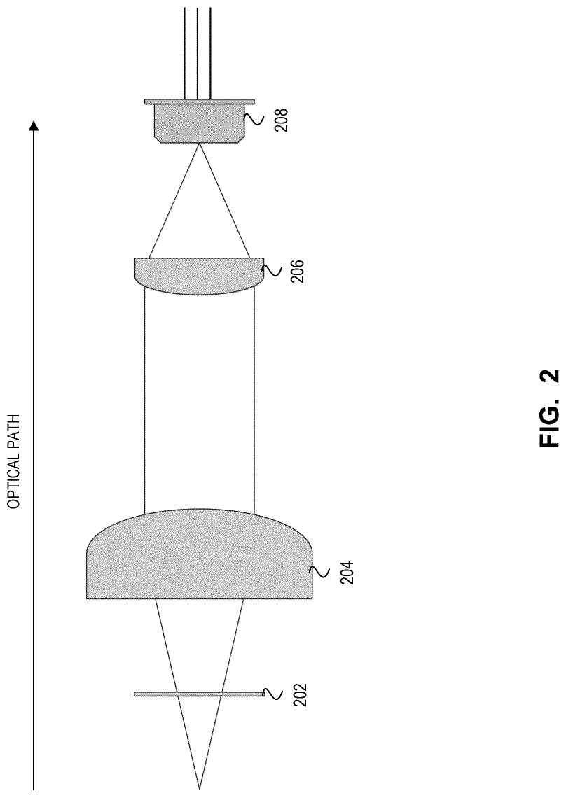

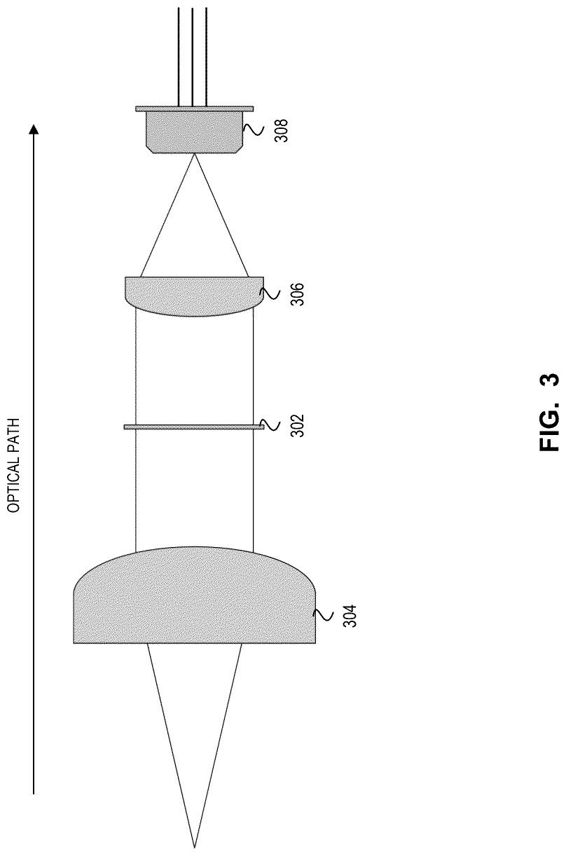

Reference is made to FIGS. 2 and 3 which illustrate the optical components and the optical path of the optical components of example PER detectors for multi-fiber devices. The optical path refers to the route that light follows as it travels through an optical system. The optical path represents the sequence of optical elements that light encounters. Specifically, FIG. 2 illustrates the optical components and optical path through those optical components of a first example PER detector for multi-fiber devices and FIG. 3 illustrates the optical components and optical path through those optical components of a second example PER detector for multi-fiber devices.

As shown in FIG. 2, the first example PER detector provides an optical path for light received by any fiber of a multi-fiber device that comprises a polarizer 202, followed by a first passive wide-area optical element (e.g., lens 204), a second passive wide-area optical element (e.g., lens 206) and a photodetector 208. The uncollimated light received from any fiber of the optical fiber is received at the rotating polarizer 202. The light that passes through the polarizer 202 is captured by the first lens 204 and converted to a collimated beam. The collimated beam is captured by the second lens 206 which focuses the beam on the photodetector 208. As described above, the photodetector 208 converts incident light into an electrical signal that represents that incident light.

As shown in FIG. 3, the second PER detector provides an optical path that comprises a first wide-area optical element (e.g., lens 304), a rotating polarizer 302, a second wide-area optical element (e.g., lens 306) and a photodetector 308. The uncollimated light received from any fiber of the optical fiber is captured by the first lens 304 and converted to a collimated bean. The collimated beam is received at the rotating polarizer 302. The light that passes through the rotating polarizer 302 is collected by the second lens 306 which focuses the collected light on the photodetector 308. As described above, the photodetector converts incident light into an electrical signal that represents that incident light.

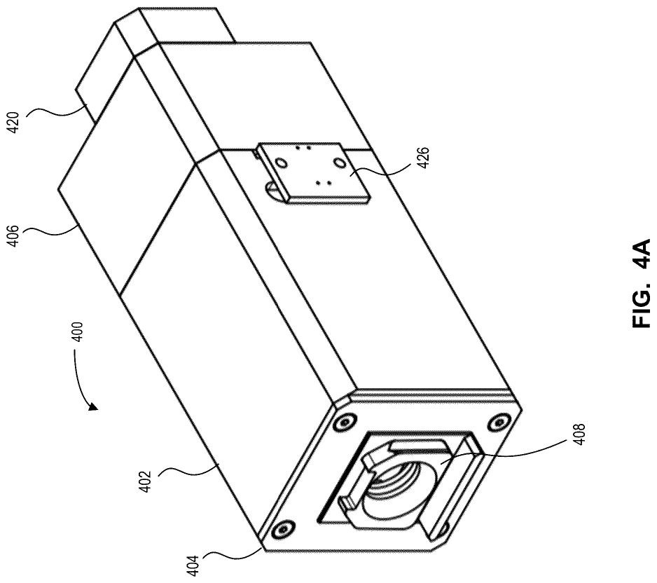

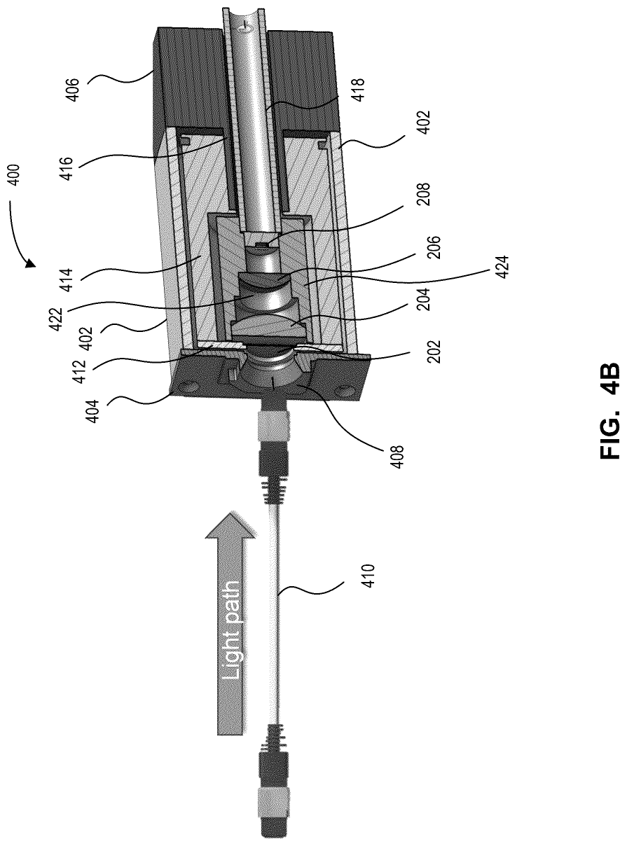

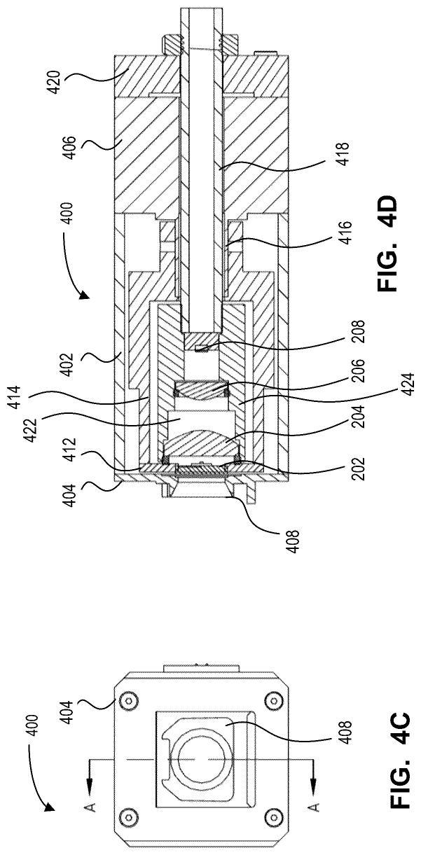

Reference is now made to FIGS. 4A, 4B, 4C and 4C which show an example PER detector 400 with the optical components and the optical path shown in FIG. 2. Specifically, the PER detector 400 provides an optical path for light received from any fiber of a multi-fiber device that comprises a polarizer 202, followed by a first wide-area optical element (e.g., lens 204), a second wide-area optical element (e.g., lens 206) and a photodetector 208. FIG. 4A shows an isometric view of the example PER detector 400, FIG. 4B shows an isometric view of a cross section of the PER detector 400 along line A-A (shown in FIG. 4C), FIG. 4C shows a front view of the PER detector 400, and FIG. 4D shows a side view of a cross section of the PER detector 400 along line A-A.

The PER detector 400 comprises an outer case 402 for housing the optical components (i.e., polarizer 202, lenses 204, 206 and photodetector 208), an adaptor plate 404 mounted to one end of the outer case 402, and a motor 406 mounted to the opposite end of the outer case 402.

The adaptor plate 404 comprises an adaptor 408 for coupling a multi-fiber device 410 to the detector 400 and more particularly, for coupling a multi-fiber device 410 to the detector 400 such that light output from any of the fibers of the multi-fiber device follows the optical path provided by the detector 400. In some cases, the adaptor 408 may comprise a receptacle configured to receive a multi-fiber push-on (MPO) connector. An MPO connector is a fiber optic connector that allows for the termination of multiple fibers in a single connector.

The motor 406 is configured to drive rotation of the polarizer 202. Specifically, the polarizer 202 is mounted to a polarizer plate 412; the polarizer plate 412 is mounted to a rotating block 414; and the rotating block 414 is attached to a rotating shaft 416 of the motor 406. Thus, rotation of the rotating shaft 416 causes the rotating block 414 and thus the polarizer 202 to rotate. In some cases, the motor 406 is a two-phase stepper motor. However, the motor 406 may be any suitable motor.

The photodetector 208 is mounted to the end of a stationary shaft 416 that is situated in the outer case 402. The stationary shaft 418 extends through the motor 406, and the rotating shaft 416. Accordingly, the stationary shaft 418 is concentric with the rotating shaft 416 of the motor 406. The stationary shaft 418 is held in place by a stationary shaft mounting plate 420 which is attached to the rear of the motor 406. The stationary shaft 418, unlike the rotating shaft 416, does not rotate. This allows the polarizer 202 to rotate with respect to the photodetector 208. Although not shown in FIGS. 4A-4D, the photodetector 208 may be coupled to a cable which can be used to send the output of the photodetector 208 to an external device, such as an optical power measurement (OPM) device. In such cases, the cable may run along inside the stationary shaft 418 until it exits the PER detector 400.

The optical lenses 204, 206 are mounted inside the internal cavity 422 of a lens block 424 such that the optical axes of the optical lenses 204, 206 are aligned. The lens block 424 is mounted to the stationary shaft 418 such that (a) the lens block 424 (and thus the optical lenses 204, 206) is stationary; (b) the photodetector 208 is situated in the internal cavity 422; and (c) the center of the photodetector 208 is aligned with the optical axes of the optical lenses 204, 206. The lens block 424 is cylindrical in shape.

In the example shown in FIGS. 4A-4D the rotating block 414 is also cylindrical in shape and surrounds the lens block 424 such that the rotating block 414 rotates around the lens block 424.

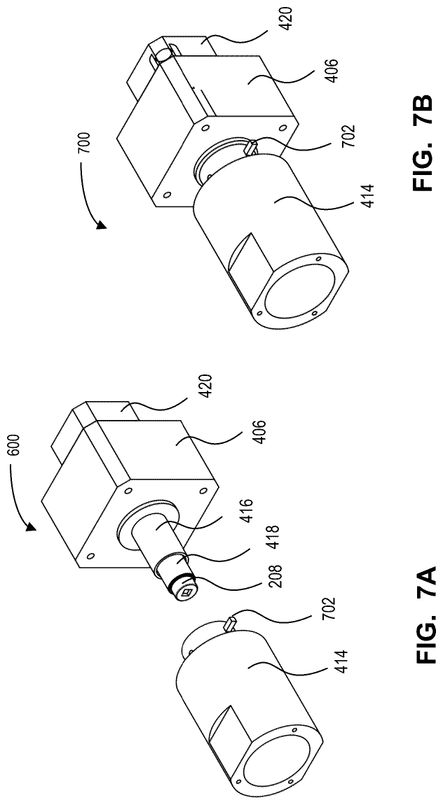

In the example shown in FIGS. 4A-4D the PER detector 400 also comprises a rotation sensor 426 which is configured to sense the angle of rotation of the polarizer 202 by detecting a trigger element that rotates with the polarizer 202. In the example shown in FIGS. 4A-4D the rotation sensor 426 comprises a photo-interrupter which is configured to detect that the polarizer 202 is at a predetermined rotation angle (e.g., a rotation angle of 0 degrees) when a physical trigger element 702 (FIGS. 7A and 7B), which is affixed to the rotating body, breaks the transmit and receive path of the photo-interrupter. When the rotation sensor 426 detects the trigger, the rotation sensor 426 may be configured to emit a trigger signal. The trigger signal may be used to notify a measurement device when to start sampling the electrical signal output by the photodetector.

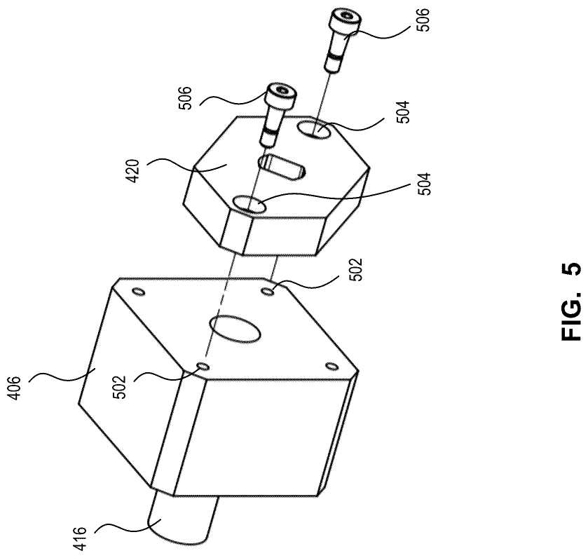

Reference is now made to FIGS. 5-12B which illustrate how the PER detector 400 of FIGS. 4A-4D may be assembled.

First, as shown in FIG. 5, the stationary shaft mounting plate 420 is attached to the motor 406. FIG. 5 shows an exploded view of the motor 406 and the stationary shaft mounting plate 420. The motor 406 comprise receptacles 502 for receiving a fastener 506, the stationary shaft mounting plate 420 comprises apertures 504, and the stationary shaft mounting plate 420 is attached to the motor 406 by placing a fastener 506 through each apertures 504 into a corresponding receptacle 502.

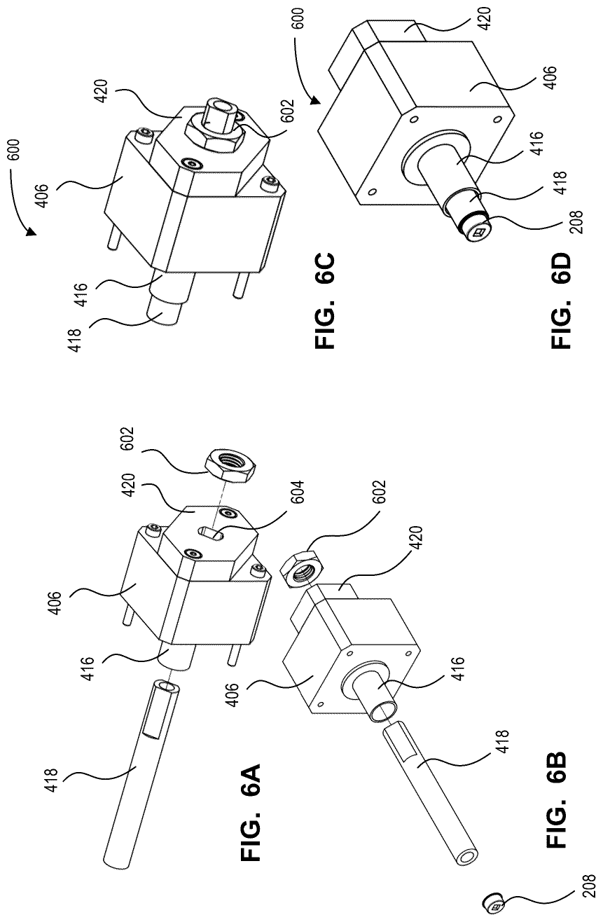

Next, as shown, FIGS. 6A-6D the stationary shaft 418 is attached to the motor 406 via the stationary shaft mounting plate 420. FIGS. 6A and 6B show exploded views of the stationary shaft 418; the motor 406 and stationary shaft mounting plate 420 combination; and a nut 602, and FIGS. 6C and 6D show the stationary shaft attached to the motor 406. An end of the stationary shaft 418 is affixed to the photodetector 208, then the stationary shaft 418 is inserted into the rotating shaft 416 of the motor 406 until the opposite end of the stationary shaft 418 extends out through a shaft aperture 604 of the stationary shaft mounting plate 420 where it is held in place there by screwing the nut 602 onto that end of the stationary shaft 418. The combination of the motor 406, stationary shaft mounting plate 420 and the stationary shaft 418 is identified by element 600.

Next, as shown in FIGS. 7A and 7B the rotating block 414 is mounted to the motor 406. FIG. 7A shows an exploded view of the rotating block 414, and the stationary shaft 418, motor 406 and stationary shaft mounting plate 420 combination (i.e., element 600) described with respect to FIGS. 6A-6D, and FIG. 7B shows the rotating block 414 mounted to the motor 406. The rotating block 414 has a hollow center and the rotating block 414 is position such that the rotating shaft 416 and a portion of the stationary shaft lie in the hollow center. The rotating block 414 is then attached to the motor 406. Specifically, the rotating block 414 is clamped to the rotating shaft 416 and then fixed with a pair of set screws, 180 degrees apart. The combination of element 600 and the rotating block 414 is identified as element 700.

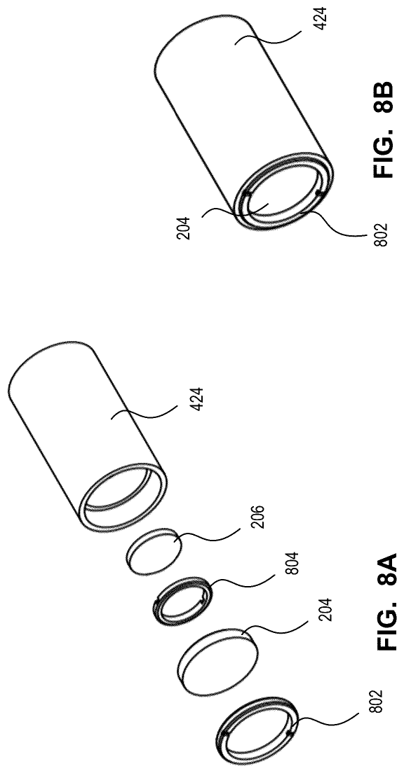

Next, as shown in FIGS. 8A and 8B, the lenses 204, 206 are mounted in the lens block 424. FIG. 8A shows an exploded view of the lenses 204, 206 and the lens block 424 and FIG. 8B shows the lens block 424 with the lenses 204, 206 mounted therein. Each lens 204, 206 is mounted within a corresponding retaining ring 802, 804 which is mounted within the lens block 424.

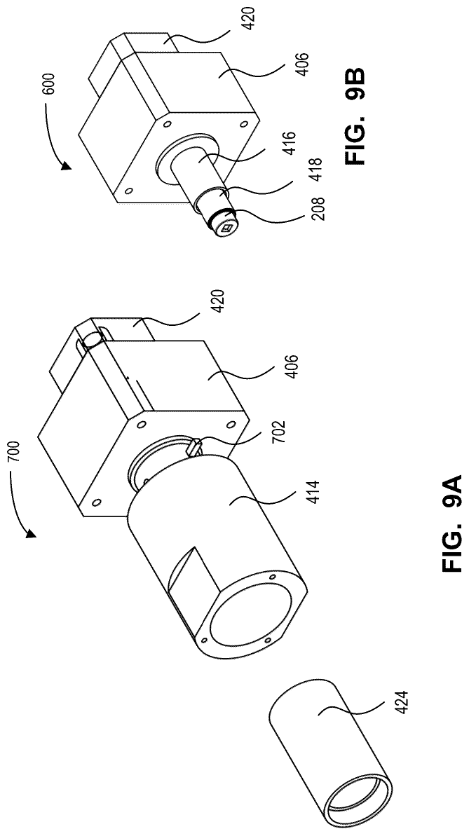

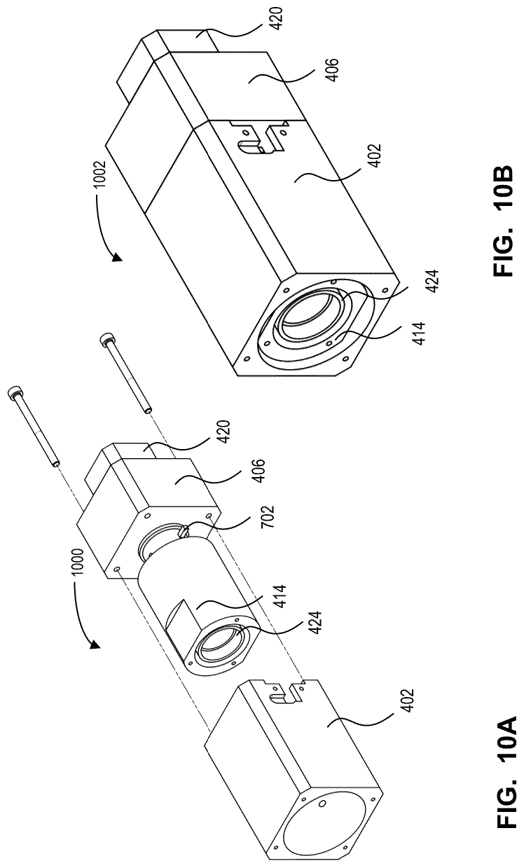

Next, as shown in FIGS. 9A and 9B, the lens block 424 comprising the lenses 204, 206 is mounted within the rotating block 414. FIG. 9A shows an exploded view of the lens block 424 and the rotating block 414, motor 406 and stationary shaft mounting plate 420 combination (i.e., element 700); and FIG. 9B shows the stationary shaft 418, motor 406 and stationary shaft mounting plate 420 combination before the rotating block 414 is attached thereto (i.e., element 600). Once the rotating block 414 is attached to the stationary shaft 418, motor 406 and stationary shaft mounting plate 420 combination as described with respect to FIGS. 8A and 8B, the lens block 424 comprising the lenses 204, 206 is inserted in the rotating block 414 and attached to the stationary shaft 418 so that the photodetector 208 lies in the internal cavity of the lens block 424. Specifically, the stationary shaft 418 has a threaded end and the lens block 424 is screwed on to the stationary shaft 418. The combination of the lens block 424 (comprising the lenses 204, 206) and element 700 is referred to as element 1000 and is shown in FIG. 10A.

Next, as shown FIGS. 10A and 10B, the outer case 402 is attached to element 1000. FIG. 10A shows an exploded view of the outer case 402, and the lens block 424, rotating block 413, motor 406 and stationary shaft mounting plate 420 combination (i.e., element 1000) described with respect to FIGS. 9A and 9B; and FIG. 10B shows the outer case 402 attached to the lens block 424, rotating block 413, motor 406 and stationary shaft mounting plate 420 combination. The combination of the outer case 402 and element 1000 is referred to as element 1002. The outer case 402 is placed around the rotating block 414 and attached to the front of the motor 406 via a set of fasteners 1102 that are inserted through a set of apertures in the motor 406 into corresponding receptacles in the outer case 402.

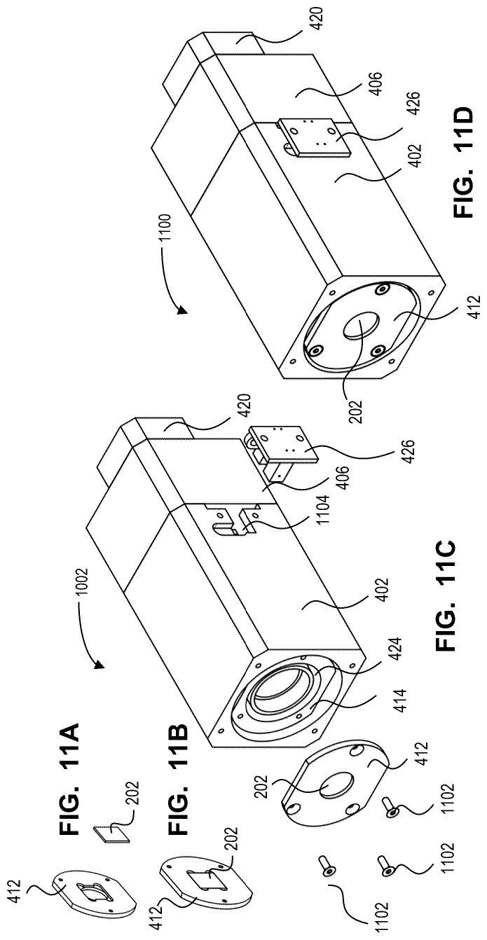

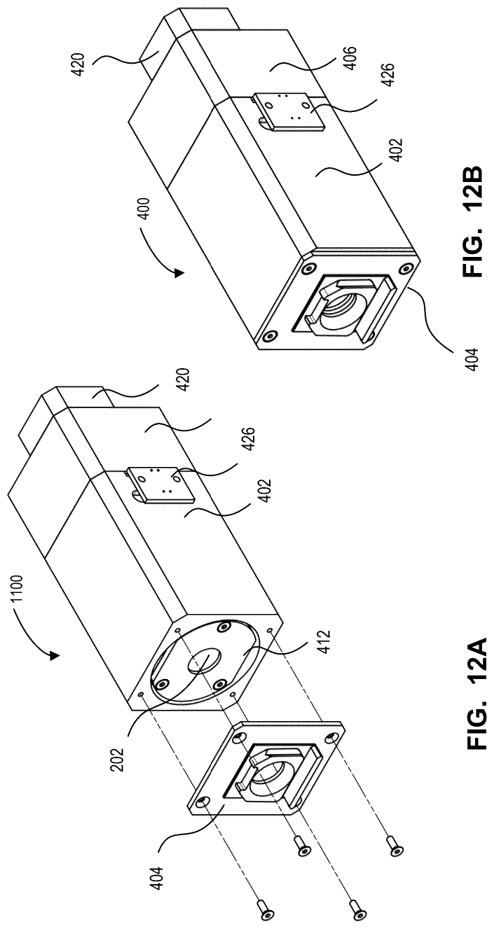

Next, as shown in FIGS. 11A-11D, the polarizer 202 is inserted in the polarizer plate 412, the polarizer plate 412 (with the polarizer 202 inserted therein) is attached to the rotating block 414, and the rotation sensor 426 is mounted to the outer case 402. FIG. 11A shows an exploded view of the polarizer plate 412 and the polarizer 202, FIG. 11B shows the polarizer plate 412 with the polarizer 202 inserted therein, FIG. 11C shows an exploded view of the polarizer plate 412 (with the polarizer 202 inserted therein) and the outer case 402, lens block 424, rotating block 414, motor 406 and stationary shaft mounting plate 420 combination (i.e., element 1002) described with respect to FIGS. 10A and 10B, and FIG. 11D shows the polarizer plate 412 (with the polarizer 202 inserted therein) attached to the outer case 402, lens block 424, rotating block 414, motor 406 and stationary shaft mounting plate 420 combination (i.e., element 1002) described with respect to FIGS. 10A and 10B. In this example, the polarizer 202 is inserted in a slot within the polarizer plate 412 and the polarizer plate 412 is mounted to the rotating block 414 via fasteners 1102. In particular, one end of each fastener 1002 passes through an aperture in the polarizer plate 412 and is received in corresponding receptacle in a front face of the rotating block 414. The rotation sensor 426 is inserted into a slot 1104 in a side of the outer case 402 and attached thereto via a fastener. The combination of the polarizer plate 412 (with the polarizer 202 inserted therein) is referred to as element 1100.

The last step, as shown in FIGS. 12A and 12B is attaching the adaptor plate 404 to the polarizer plate 412, outer case 402, lens block 424, rotating block 414, motor 406 and stationary shaft mounting plate 420 combination (i.e., element 1100) described with respect to FIGS. 11C and D. FIG. 12A shows an exploded view of the adaptor plate 404 and the polarizer plate 412, outer case 402, lens block 424, rotating block 414, motor 406 and stationary shaft mounting plate 420 combination described with respect to FIGS. 11C and D; and FIG. 12B shows the adaptor plate 404 attached to the polarizer plate 412, outer case 402, lens block 424, rotating block 414, motor 406 and stationary shaft mounting plate 420 combination. In this example, the adaptor plate 404 is mounted to the outer case 402 via fasteners. In particular, one end of the fasteners pass through apertures in the adaptor plate 404 into corresponding receptacles in a front face of the outer case 402.

In some cases, the PER detectors described herein, such as the PER detector 400, may be used in a system for automatically measuring the PER of each fiber in a multi-fiber device.

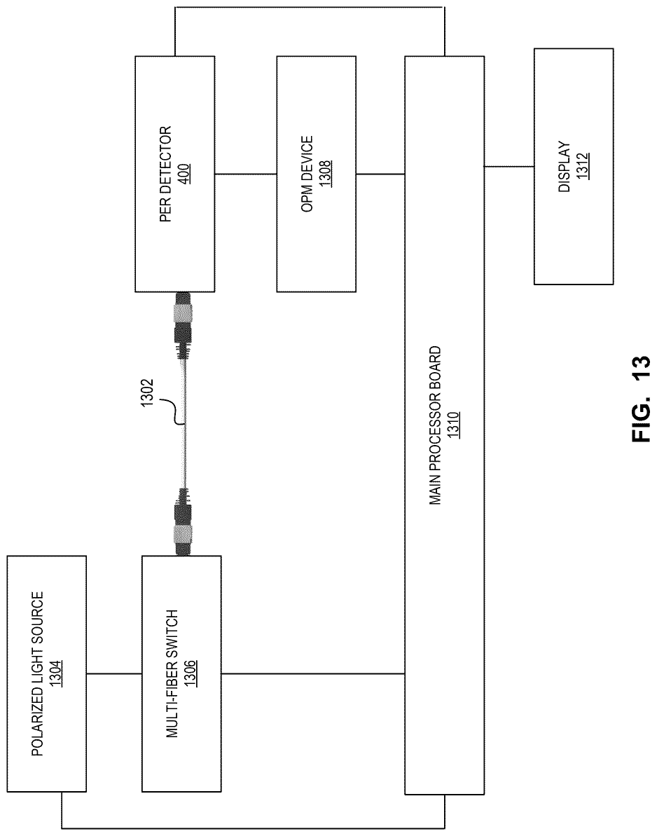

Reference is now made to FIG. 13 which illustrates an example system 1300 for automatically measuring the PER of each fiber in a multi-fiber device 1302 that comprises the PER detector 400 described herein. The system 1300 also comprises a polarized light source 1304, a multi-fiber switch 1306, an optical power measurement (OPM) device 1308 and a main processor board 1310. In some cases, the system 1300 may also include a display 1312.

One end of the multi-fiber device 1302 under test is coupled to an adaptor (not shown) of the multi-fiber switch 1306 and the other end of the multi-fiber device 1302 is coupled to the adaptor 408 of the PER detector 400.

The polarized light source (PLS) 1304 is configured to generate, in response to a control signal from the main processor board 1310, light with a well-defined polarization. The polarized light source 1304 may comprise a laser that is configured to generate the polarized light. The light generated by the polarized light source 1304 is provided to the multi-fiber switch 1306.

The multi-fiber switch 1306 is configured to receive light from a light generating source coupled thereto and selectively output the received light to a fiber of a multi-fiber device coupled thereto. The multi-fiber switch 1304 of FIG. 13 is specifically configured to receive polarized light from the polarized light source 1304 and, in response to a control signal received from the main processor board 1310 direct the received polarized light to one fiber of the multi-fiber device 1302 under test. To be able to measure the PER for each fiber of the multi-fiber device 1302 under test, the main processor board 1310 may be configured to cause the multi-fiber switch 1306 to direct polarized light generated by the polarized light source 1304 to each fiber of the multi-fiber device.

The PER detector 400 is configured to receive light output from the multi-fiber device 1302 in turn output an electrical signal that represents the portion of the received light that passed through the rotating polarizer. As the polarized light source 1304 and the multi-fiber switch 1306 cycle through the fibers the electrical signal output by the PER detector 400 will correspond to the light received on different fibers.

The optical power meter (OPM) device 1308 is configured to receive the electrical signal and convert the electrical signal into sets of power values wherein each set correspond to power values over a predetermined amount of rotation of the polarizer (e.g., 180 degrees). The polarizer is symmetric through 180 degrees so all of the information to be able to compute the PER for a fiber can be obtained through 180 degrees of rotation and it is not necessary to obtain information for the remaining 180 degrees. In some cases, where the PER detector 400 is configured to detect when the polarizer is at a predetermined rotation angle (e.g., 0 degrees) then the optical power meter (OPM) device 1308 may be configured to, when it receives a trigger signal from the PER detector 400, capture a predetermined number of samples of the electrical signal output by the PER detector 400 that represent the electrical signal over a 180 degree rotation of the polarizer of the PER detector 400. Once the OPM device 1308 has obtained a set of samples it may convert the samples into power values, identify the maximum and minimum of power values in the set, and output the identified maximum and minimum power values to the main processor board. There will be at least one set of samples and thus at least one pair of maximum and minimum power values for each fiber. Although the OPM device 1308 does not know which fiber is being testing at any time, it will collect samples each time it receives a trigger signal.

In some cases, the OPM device 1308 may also identify for each set of samples, the sample (and thus the angle) at which the maximum power occurred and also output that to the main processor board 1310.

The main processor board 1310, is configured to, in addition to coordinating the operation of the other components in the system 1300 compute, for each fiber of the multi-fiber device 1302, the PER for each fiber based on the maximum and minimum power values output by the OPM device 1308. This may comprise identifying which maximum, minimum pairs correspond to each of the fibers. The main processor board 1310 is responsible for keeping track of which fiber is currently being tested and when a set of samples obtained by the OPM device 1308 (and thus the maximum and minimum power values generated thereof) are valid. Therefore, in some cases, when the multi-fiber optical switch changes to the next fiber, the main processor board 1310 may also set a Boolean value to false to indicate that the next set of samples obtained by the OPM device (and thus the maximum and minimum power values generated therefrom) are not valid. This means that the next pair of maximum and minimum power values are ignored since it has occurred during a fiber switch. Once the main processor board 1310 knows that the switch has changed fibers and has settled it sets the bit back to true and the next pair of maximum, minimum power values are accepted as valid for the fiber currently under test. The computed PERs may be displayed on a display 1312.

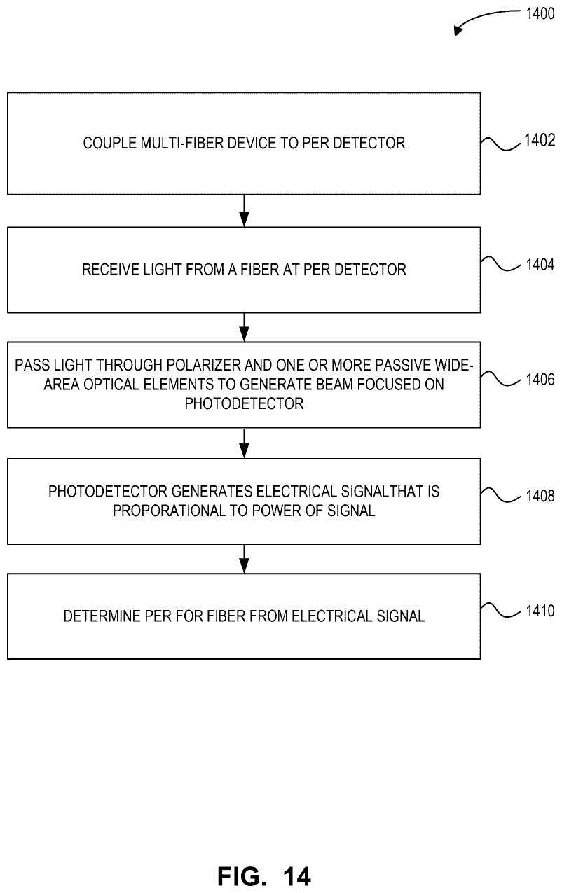

Reference is now made to FIG. 14 which illustrates an example method 1400 for measuring the PER of one or more fibers of a multi-fiber device using one of the PER detectors for multi-fiber devices described herein, such as the PER detector 400. The method begins at block 1402 where the multi-fiber device is coupled to a PER detector described herein, such as, but not limited to, PER detector 400. At block 1404 light from a fiber of the multi-fiber device is received at the PER detector. At block 1406 the receive light is passed through a rotating polarizer and at least one passive wide-area optical element of the PER to generate a beam that is focused on a photodetector of the PER detector. The rotating polarizer rotates with respect to the photodetector. At block 1408 the photodetector converts the received beam of light into an electrical signal that is proportional to the power of the beam. At block 1410 the PER for the fiber is generated based on the electrical signal generated by the photodetector. For example, as described above, the electrical signal may be sampled a number of times to represent the light output from the polarizer for different angles of rotation of the polarizer; each sample may be converted into a corresponding power value; and the PER may be determined from the maximum and minimum of those power values as described above. In some cases, the angle may also be computed from the electrical signal. While the multi-fiber device is still coupled to the PER detector blocks 1404 to 1414 may be repeated for another, different, fiber of the multi-fiber device.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A polarization extinction ratio detector for a multi-fiber device, the detector comprising:
an adaptor for coupling the multi-fiber device to the detector;
a photodetector for converting light to an electrical signal;
a polarizer that is rotatable with respect to the photodetector; and
at least one passive wide-area optical element;
wherein the photodetector, polarizer and at least one passive wide area optical element are positioned such that, when the multi-fiber device is coupled to the detector, light output by any fiber of the multi-fiber device follows an optical path through the polarizer and the at least one wide-area optical element to generate a beam that is focused on the photodetector.

2. The detector of claim 1, wherein the at least one passive wide-area optical element comprises a plurality of passive wide-area optical elements.

3. The detector of claim 2, wherein the polarizer is positioned in the optical path between two of the plurality of passive wide-area optical elements.

4. The detector of claim 1, wherein the polarizer is positioned in the optical path before each of the at least one passive wide-area optical element.

5. The detector of claim 1, wherein the polarizer is positioned in the optical path after each of the at least one passive wide-area optical element.

6. The detector of claim 1, wherein an axis of rotation of the polarizer is parallel to an optical axis of the multi-fiber device.

7. The detector of claim 1, further comprising a motor coupled to the polarizer for driving the rotation of the polarizer.

8. The detector of claim 7, wherein the photodetector is mounted to a stationary shaft and the polarizer is mounted to a rotatable shaft of the motor that is concentric with the stationary shaft.

9. The detector of claim 1, wherein each of the at least one passive wide-area optical element is a light collecting lens.

10. The detector of claim 1, wherein the at least one passive wide-area optical element comprises a pair of plano-aspherical lenses.

11. The detector of claim 1, further comprising a measurement device coupled to the photodetector, the measurement device configured to generate the PER for a fiber of the multi-fiber device based on the electrical signal generated by the photodetector while that fiber is outputting light.

12. The detector of claim 11, further comprising a rotation sensor, and wherein the polarizer is coupled to a trigger element that rotates with the polarizer and the rotation sensor is configured to detect when the trigger element is in a predetermined position and, in response to detecting that the trigger element is in the predetermined position, send a trigger signal to the measurement device which causes the measurement device to obtain a plurality of samples of the electrical signal.

13. The detector of claim 12, wherein the rotation sensor is a photo-interrupter.

14. The detector of claim 11, wherein the measurement device is further configured to determine a polarization angle for the fiber based on the electrical signal generated by the photodetector while that fiber is outputting light.

15. The detector of claim 11, wherein the measurement device comprises an optical power measurement device.

16. The detector of claim 1, further comprising a diverging lens positioned such that a collimated beam passes through the diverging lens before being passed through the polarizer and the at least one passive wide-angle optical element.

17. The detector of claim 1, wherein the photodetector is a photodiode.

18. The detector of claim 1, wherein the adaptor is configured to receive a fiber array unit (FAU).

19. A method of determining a polarization extinction ratio (PER) of multiple fibers in a multi-fiber device, the method comprising:
(a) coupling the multi-fiber device to a PER detector;
(b) receiving, at the PER detector, light from a fiber of the multi-fiber device;
(c) passing the received light through a rotating polarizer and at least one wide-area optical element of the PER detector to generate a beam that is focused on a photodetector of the PER detector, the rotating polarizer rotating with respect to the photodetector;
(d) converting, at the photodetector, the beam into an electrical signal;
(e) generating the PER for the fiber based on the electrical signal generated by the photodetector; and
(f) while the multi-fiber device is coupled to the PER detector, repeating (b) to (e) for a different fiber of the multi-fiber device.

20. A system for determining a polarization extinction ratio (PER) of each fiber in a multi-fiber device, the system comprising:
a light source;
a multi-fiber switching unit coupled to the light source;
a first adapter for coupling a first end of a multi-fiber device to the multi-fiber switching unit, the multi-fiber switching unit configured to automatically cause the light source to sequentially provide light to each fiber of the multi-fiber device;
a second adaptor for coupling a second end of the multi-fiber device to a PER detector, the PER detector comprising:
a photodetector for converting light to an electrical signal,
a polarizer that is rotatable with respect to the photodetector, and
at least one passive wide-area optical element;
wherein the photodetector, polarizer and at least one passive wide area optical element are positioned such that light output by any fiber of the multi-fiber device follows an optical path through the polarizer and the at least one wide-area optical element to generate a beam that is focused on the photodetector; and
a measurement device coupled to the photodetector, the measurement device configured to generate the PER for each fiber of the multi-fiber device based on the electrical signal generated by the photodetector while that fiber is outputting light.
